(19) United States
(12) Patent Application Publication
(10) Pub. No.: US 2016/0359991 A1
(43) Pub. Date: Dec. 8, 2016

(54) RECOMMENDER SYSTEM FOR AN ONLINE MULTIMEDIA CONTENT PROVIDER

(71) Applicant: Ecole Polytechnique Federale de Lausanne (EPFL), Lausanne (CH)

(72) Inventors: Florent GARCIN, Lausanne (CH); Boi Faltings, Preverenges (CH)

(73) Assignee: Ecole Polytechnique Federale de Lausanne (EPFL), Lausanne (CH)

(21) Appl. No.: 14/733,304

(22) Filed: Jun. 8, 2015

(51) Int. Cl. H04L 29/08; G06F 17/21; G06F 17/22; G06F 17/24; G06F 3/0484; G06F 3/0485

(52) U.S. Cl. CPC H04L 67/22; H04L 67/02; G06F 3/04842; G06F 3/0485; G06F 17/2247; G06F 17/24; G06F 17/211

(57) ABSTRACT

A recommender system for determining multimedia items to be presented in an online interface of a multimedia content provider. The recommender system continuously observes the user's behavior in order to define a context for the user which on the basis of which recommendations are computed. The recommender system observes a variety of events so as to improve the level of pertinence of the recommendations which are presented to the user in the online interface. The recommender system further observes the collection of multimedia items which are hosted by an online multimedia content provider system.

### FIELD OF THE INVENTION

The present invention concerns the field of recommender systems. The present invention relates in particular to a system for determining multimedia content to be presented in an online interface of an online multimedia content provider which hosts a collection of multimedia items when a user browses said online interface with a computing device.

### BACKGROUND OF THE INVENTION

Online multimedia content provider systems, such as Youtube®, Netflix® or Dailymotion®, are nowadays well known and so are basic browsing functionalities by online interfaces of such systems. Such basic browsing functionalities usually include means for retrieving multimedia content, multimedia content players and means for subscribing to multimedia content related services.

It is also known that when one browses, usually through a web page retrieved via an internet browser, an online interface of an online multimedia content provider system in order to retrieve a specific multimedia item, for instance a video or a music file, the online multimedia content provider system uses a recommender system to determine recommendations. For instance, when one browses the online interface of an online video content provider system, one part of the interface is dedicated to displaying of a list of videos that is determined automatically by the online multimedia content provider system. This list contains recommended or suggested multimedia items that have been determined to be somehow pertinent to the user by the recommender system. Recommender systems are also known in the context of online merchants, in particular for suggesting purchasable items. For instance, on Amazon®, when one looks for a specific item to purchase, a part of the online interface is dedicated to displaying of other items that have been purchased by users which have also looked for the specific item.

However, an issue that is specific to recommender systems to be used by online multimedia content providers is that, in contrast to recommender systems which are used by online merchants, most websites operated by online multimedia content providers do not have a strong base of subscribers. Visitors to these websites are casual users, often accessing them through a search engine, and little is known about these users except what can be gathered though an ephemeral browsing history. Consequently, common recommender techniques, such as collaborative filtering, that are applied for recommending purchasable items cannot be applied to multimedia content. Moreover, in contrast to a catalogue of purchasable items of an online merchant that remains more or less constant over time, multimedia items hosted by multimedia content providers are rapidly evolving. For instance, each day, there are hundreds of hours of new content that are uploaded on Youtube®. Furthermore, in the specific context of online news providers, another challenge that recommender systems have to face is that new stories and topics appear and disappear quickly and old news are no longer interesting.

For these reasons, recommender systems that are used by online multimedia content providers nowadays are not efficient when they are applied specifically in the context of online content provider systems in the sense that recommendations that they provide are usually not pertinent to users.

### SUMMARY OF THE INVENTION

The goal of the present invention is thus to provide a technical improvement in the field of recommender systems applied to online environments by addressing in particular the constraints that affect such systems when they are applied in relation with online multimedia content provider systems. As such, the recommender system of the invention must, despite the lack of information available about users of online multimedia content provider systems, improve the level of pertinence of the recommendations that are provided to users. The recommender system of the invention must also work efficiently with large and constantly evolving collections of items.

These goals are achieved with a system for determining multimedia content to be presented in an online interface of an online multimedia content provider which hosts a collection of multimedia items when a user browses said online interface with a computing device, said system comprising at least one processor that executes computer-executable code stored in memory to effect the following:
means for observing one or more events, wherein said one or more events are at least partly induced by one or more actions performed by said user;
means for defining one or more context related parameters for said user, wherein said context related parameters are determined in relation with said user browsing behavior; and
means for processing said one or more events and said one or more context related parameters to select one or more multimedia items from said collection.

According to one characteristic, said one or more actions may include selection actions, scrolling actions and multimedia content browsing related actions.

According to another characteristic, said one or more events may include automatically generated events, said automatically generated events being generated by said system without any input form said user

According to another characteristic, said means for observing one or more events may comprise means for determining one or more additional parameters for at least one of said one or more events.

According to another characteristic, said one or more events may include updating means for observing one or more changes that occur with respect to said collection of multimedia items.

According to another characteristic, said means for observing one or more events may include means for translating at least one part of a multimedia item into data in text format.

According to another characteristic, said means for observing one or more events may include means for retrieving data in text format associated with a multimedia item.

According to another characteristic, said context related parameters may include a list of one or more multimedia items.

According to another characteristic, said context related parameters may include a list of one or more topics.

According to another characteristic, said context related parameters may include a list of one or more topic distributions.

According to another characteristic, said means for defining one or more context related parameters for said user may include means for analyzing multimedia items.

According to another characteristic, said means for processing said one or more events and said one or more context related parameters may include means for computing one or more predictions on the basis of said one or more events and said context related parameters.

According to another characteristic, said means for processing said one or more events and said one or more context related parameters may include means for computing at least one recommendation on the basis of said one or more predictions.

According to another characteristic, said means for processing said one or more events and said one or more context related parameters may include means for allocating one or more weighting parameters to said one or more context related parameters.

According to another characteristic, said means for processing said one or more events and said one or more context related parameters may include means for updating said one or more weighting parameters on the basis of said one or more events.

According to another characteristic, said means for processing said one or more events and said one or more context related parameters may include means for allocating one or more confidence parameters to said one or more predictions.

According to another characteristic, each one of said one or more predictions and said recommendation may include a ranked list of multimedia items selected from a set including one or more candidates.

### BRIEF DESCRIPTION OF THE DRAWINGS

Other advantages and features of the invention will become more clearly apparent from the following description of the invention which refers to the accompanying drawings, in which:

FIG. 1 schematically shows a recommender system according to invention;

FIG. 2 schematically shows the modules included in the recommender system according to the invention.

### DETAILED DESCRIPTION

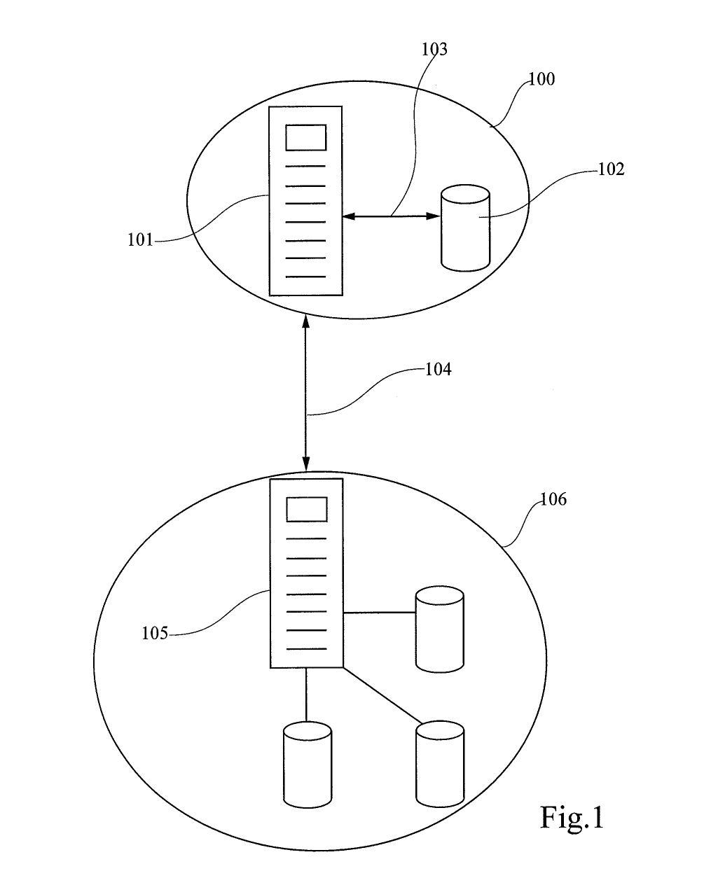

FIG. 1 schematically shows the essential components of a computer system for determining multimedia content to be presented in an online interface of an online multimedia content provider system according to the invention, hereinafter referred to as the recommender system 100 or the system 100.

The recommender system 100 includes a computing device 101, which includes one or more processors, and a data storage device 102, which includes one or more data storage media. The computing device 101 and the data storage device 102 are connected together via a communication channel 103 and communication interfaces so that the computing device 101 is able to store data on the data storage device 102 and to retrieve data from the data storage device 102. The computing device 101 further comprises a communication interface enabling the computing device to be connected with an online multimedia content provider system through a dedicated communication channel 104. As will be understood by those skilled in the art, the computing device 101 and the data storage device 102 include hardware, software and they may be implemented in a physical or a virtualized environment.

In one embodiment, the recommender system 100 is part of an online multimedia content provider 106 system, for instance implemented by a dedicated server 105. Preferably, the recommender system 100 is, as depicted in FIG. 1, a stand-alone computer system which is connected to the online multimedia content provider system 106 through a dedicated communication channel 104. As usual, the online content provider system 106 comprises at least one or more storage devices 107 which host a collection of multimedia items and one or more computing devices 105 which at least implement an online interface to the collection. The online interface is presented to a user when the user connects to the online multimedia content provider system, usually via a dedicated web page retrieved in a web browser executed on a computing device such as a laptop, a desktop, a smartphone or any other device that may be used to browse Internet.

Although functionalities of the recommender system 100 are described below in relation with a single user, the recommender system 100 is able to handle similarly a number of users, in particular all the users that at a certain point in time interact with an online interface of an online multimedia content provider system. In the sense of the invention, the term “module” should be interpreted in the context of computer systems, i.e. as including hardware and/or software configured to implement specific functionalities.

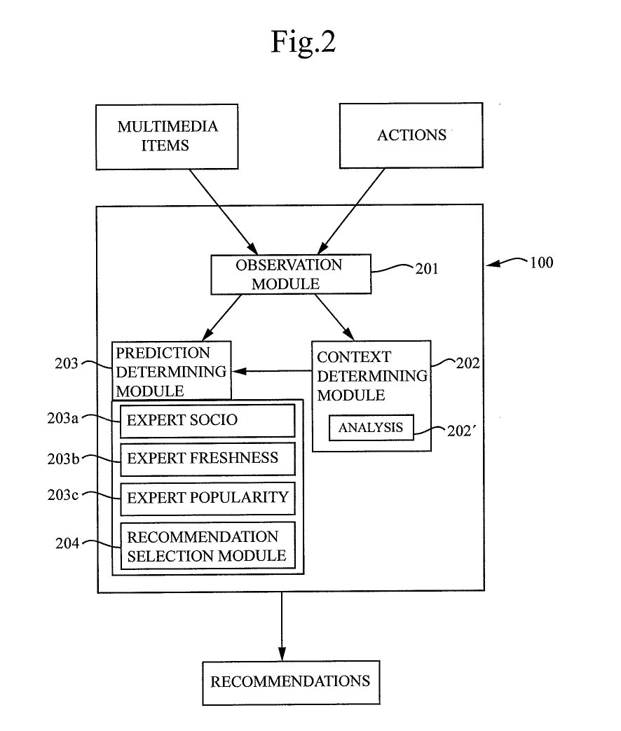

FIG. 2 shows the main modules of the recommender system 100 of the invention which allow to provide pertinent recommendations to users in the context of online multimedia content provider system.

The recommender system 100 comprises an observation module 201 configured to observe events that occur. These observed events either correspond to explicit or implicit actions performed by the user when browsing the online interface or are automatically generated by the recommender system 100.

Actions performed by the user when browsing the online interface include selection actions, scrolling actions and multimedia content browsing related actions. Selection actions and scrolling actions include actions performed by the user interacting with the online interface whereas multimedia content browsing actions include more specifically actions performed by the user when interacting with multimedia items.

Selection actions relate to actions of using dedicated means, for instance a pointing device (mouse, trackball, etc.), to select a particular link or a particular multimedia item displayed on the online interface. Scrolling actions include start scrolling actions, i.e. when the user starts to scroll on the displayed page, and stop scrolling actions, i.e. when the user stop scrolling on the displayed page.

Multimedia content browsing related actions include play actions, when the user performs an action so that a multimedia item is being played, stop actions, when the user performs an action so that a multimedia item being played is stopped, pause actions, when the user performs an action so that a multimedia item being played is paused, fast forward actions, when the user performs an action so that a multimedia item being played is forwarded, rewind actions, when the user performs an action so that a multimedia item being played is rewound, jump actions, when the user performs an action so that a multimedia item being played jumps directly from one timing reference to another, and time action, when the user reaches a play milestone corresponding to an amount of play time. Multimedia content browsing related actions may be performed by the user through a web player (video or audio) as those which are usually part of an online interface of an online multimedia content provider system.

Alternatively, multimedia content browsing related actions may be only indirectly related to the user input. For instance, when the user performs a selection action on a multimedia item, the selected multimedia item is automatically played and, in this case, a play action, which corresponds to a multimedia content browsing related action, is automatically generated by the system 100 and observed by the observation module 201.

On the other hand, automatically generated events correspond to events which are generated by the recommender system itself. In other terms, automatically generated events are independent from any user input. An example of an automatically generated event if a reporting event. A reporting event may for instance be generated by the system 100 when a multimedia item has been played for a certain amount of time, which exceeds a predefined threshold, or when the whole content of a multimedia item has been played.

All the above described events are observed by the observation module 201 which keeps track and records all events that occur. As will be described below, such events are part of the raw material that is used by the recommender system 100 to compute recommendations. Due to the variety of events which are observed and taken into account, the recommender system 100 is able to characterize the user's behavior in a more complete and accurate manner. Consequently, the system 100 improves the level of pertinence of the recommendations that are provided.

Moreover, when keeping track of events as described above, the observation module 201 further determines and allocates specific information to each or some event(s). For instance, with respect to a stop scroll action, which corresponds to a stop scroll event, the observation module 201 determines the time at which such event occurs and, additionally, it determines the position on the page at which the user started scrolling and the position on the page at which the user stopped scrolling. In this case, a timing related parameter and two position related parameters are recorded by the observation module 201 in relation with parameters identifying the observed stop scrolling event. Those parameters are also used to further improve the Moreover, the observation module 201 includes an updating module (not represented) for constantly keeping track of multimedia items which are present in the collection of multimedia items hosted by the online content provider system 106 to which the recommender system 100 is connected. Thus, the observation module 201 has at any point in time an up-to-date and accurate knowledge of the collection of multimedia items hosted by the online content provider system 106. Further, the observation module 201 selects periodically a set of one or more multimedia items from the collection, so-called candidates, which is used by the recommender system 100 for computing recommendations in the sense that recommendations, i.e. lists of selected multimedia items, are preferably selected amongst those candidates.

In addition, while keeping track of multimedia items present in the collection, the observation module 201 further performs analysis of multimedia items of the collection to determine topics and topics distributions. This analysis is performed for each multimedia item of the collection or, preferably for the sake of sparing computing resources, it is performed only on the selected candidates. This analysis may use speech-to-text translation functionalities, which allow to translate in text a video or audio source, or to video-transcripts retrieval and analyzing functionalities, which allow to retrieve and analyze video-transcripts associated with videos, implemented by one or more dedicated modules of the observation module 201.

Apart from the above-presented functionalities and modules, the observation module 201 role is also to continuously keep track of multimedia items which are retrieved by the user during browsing of the collection of multimedia items. This information is used by a context determination module 202 which continuously updates a context for an observed user. Thus, each time the user retrieves a new multimedia item, the observation module 201 forwards this information to the context determination module 202 which updates the user's context, said context including an ordered list of multimedia items and characterizing at any point in time an up-to-date picture of the user's browsing behavior.

More specifically, the context determination module 202 defines the user's context using a variable-order Markov model (VMM) which builds a tree where the user's context is materialized as a path in the tree. The tree is built in such a way that the root node is the most general context (a context that encapsulate everything), and the nodes deeper in the tree correspond to more and more precise contexts until reaching the node that matches the user's context. In other terms, the context determination module 202 organizes the context information as a partition tree which materializes an organized hierarchy of increasingly precise partitions in a space of contexts. This allows the context determination module 202 to continuously characterize the interactions the user has with the multimedia items of the collection.

The context determination module 202 further includes an analysis module 202′ which analyzes multimedia items that are retrieved by the user and determines what topic(s) is (are) addressed in the content of those multimedia items. When multimedia items are videos, the analysis module 202′ may use the video transcripts to determine content topics and content topic distributions.

When the user retrieves, first, a first multimedia item, multimedia item 1, and, then, a second multimedia item, multimedia item 2, the context determination module 202 defines that the context for the user is the ordered list <multimedia item 2, multimedia item 1>. Alternatively, if the analysis module 202′, looking in this case at content topics, determines that 55% of multimedia item 1 concerns a first topic, topic 1, while 45% of multimedia item 1 concerns a second topic, topic 2, and, similarly, that 55% of multimedia item 2 concerns a third topic, topic 3, while 45% of multimedia item 2 concerns a fourth topic, topic 4, the context determination module 202 defines in this case that the context for the user corresponds to the ordered list <topic 3, topic 1>. Alternatively, if the analysis module 202′, looking in this case at topic distributions, determines the topic percentages stated above, the context determination module 202 defines in this case that the user's context correspond to the list of topic distributions, i.e. the ordered list of vectors, in other terms the ordered list of n*1 matrix:

$$< ( \begin{matrix}0.55 of topic 3 \\ 0.45 of topic 4\end{matrix} ) , ( \begin{matrix}0.55 of topic 1 \\ 0.45 of topic 2\end{matrix} ) >$$

The recommender system 100 further includes a prediction determining module 203, which includes a set of one or more expert modules 203a, 203b, 203c, and a recommendation selection module 204. The expert modules 203a, 203b, 203c compute predictions which are used by the recommendation selection module 204 to determine recommendations. The recommendations computed by the recommendation selection module 204 are ultimately presented to the user in the online interface of the multimedia content provider system. Both the predictions determined by the expert modules and the recommendations computed by the recommendation selection module consists of lists of multimedia items.

Each expert module is configured to use the events observed by the observation module 201 and the user's context defined by the context determination module 202 to compute a prediction, i.e. to select from the candidates a list of one or more multimedia items. Each expert module is configured to focus on particular events and/or particular information and to compute its prediction accordingly. For instance, expert module 203a is configured to focus on socio-demographic information. In other terms, expert module 203a computes its predictions by focusing on socio-demographic aspects of the user. In contrast, expert module 203b computes its predictions by focusing solely on the time at which multimedia items become available in the collection, i.e. by taking into account whether multimedia items are fresh, i.e. recently available in the collection, or old, i.e. items that have been available in the collection for a long time. Further, expert module 203c computes its predictions by focusing on popularity of multimedia items, i.e. by taking into account whether multimedia items are popular, i.e. are regularly retrieved by a reasonable number of users, or unpopular, i.e. multimedia items that are usually not retrieved.

The prediction determining module 203 may include more than three expert modules, which may focus on other aspects than those exemplified above.

In order to allow the recommendation selection module 204 to determine a recommendation that will ultimately be presented to the user, the prediction determining module 203 first selects all contexts corresponding to the current user. In other terms, the prediction determining module determines every nodes of the tree included in the path that leads to the node that define the user's context. This selection thus forms a path in the tree from the root node, i.e. the general context, to the current most-refined user's context. For each selected node, an instance of each expert module provides a prediction, i.e. for each context that the user has or has had, the prediction determining module 203 calls an instance of each expert to compute a prediction, i.e. a selection amongst the candidates of one or more multimedia items. Further, the prediction determining module 203 allocates a weighting parameter to each context of the path in the tree, such weighting parameter characterizing the confidence of the predictions associated with the context.

Then, the recommendation selection module 204 combines the predictions provided by each expert's instance for every contexts of the path and derives a global recommendation. In doing so, the recommendation selection module 204 uses the weighting parameters allocated to the contexts. If the weighting parameter for a context is small, it means this context is not useful to contribute to the overall recommendation. When there are more than one expert modules attached to a given context, the system first combines the predictions provided by the expert modules instances to create a global prediction attached to this context. Confidence parameters are also allocated to expert modules and such parameters are used when determining the global prediction.

As said above, the recommendation is ultimately forwarded to the online content provider system and displayed in the online interface presented to the user.

Then, when recommendations are presented to the user, the observation module 201, which constantly observes the user's browsing behavior, determines how the user actually uses the provided recommendation. On the basis of the events that are observed with respect to the recommendation, the system 100 adapts automatically the weighting parameters of the contexts and the confidence parameters of the experts. For instance, if one multimedia item of the recommendation list is selected by the user, the system retrieves the expert modules and the context which are involved in the recommendation and adapts the weighting parameters and the confidence parameters accordingly, i.e. by increasing weighting parameters for certain expert modules and by decreasing weighting parameters of other modules. If a context in the tree is not useful, the weighting parameter will be adapted in such a way that this context participates less in the overall recommendation computed by the recommendation selection module 204.

Thus, the recommender system 100 of the invention is self-adaptive in the sense that, while providing recommendations, it continuously adapts itself so as to continuously increase the level of accuracy of the recommendations, i.e. to improve the pertinence of recommendations with respect to the user's browsing behavior which is constantly observed. More specifically, the system of the invention adapts itself at two levels, one by adjusting the weighting parameters of the contexts and the other by continuously adjusting the experts' confidence parameters.

The advantage of this system is two-folds. First, if some experts are not useful, they will be allocated small weighting parameters and their contribution to the overall recommendation will thus become marginal. Second, the context is also adaptive. For instance, a context which is too refined might not be useful for recommendation. Thus If a context is not useful, it will not contribute to the overall prediction. When the system makes an observation about a given user, the system will first retrieves all corresponding contexts forming the path in the tree from the root node to the current node reflecting the current context of that user. The system then updates the weight of each context based on what the context predicted and what actually has been observed. As the system does that, it will also check each expert module inside each context and update the weighting parameter associated to each expert module based on what the expert module predicted and what actually has been observed.

What is claimed is:

1. A system for determining multimedia content to be presented in an online interface of an online multimedia content provider which hosts a collection of multimedia items when a user browses said online interface with a computing device, said system comprising at least one processor that executes computer-executable code stored in memory to effect the following
means for observing one or more events, wherein said one or more events are at least partly induced by one or more actions performed by said user;
means for defining one or more context related parameters for said user, wherein said context related parameters are determined in relation with said user browsing behavior; and
means for processing said one or more events and said one or more context related parameters to select one or more multimedia items from said collection.

2. The system of claim 1, wherein said one or more actions include selection actions, scrolling actions and multimedia content browsing related actions.

3. The system of claim 1, wherein said one or more events include automatically generated events, said automatically generated events being generated by said system without any input form said user

4. The system of claim 1, wherein said means for observing one or more events comprise means for determining one or more additional parameters for at least one of said one or more events.

5. The system of claim 1, wherein said one or more events include updating means for observing one or more changes that occur with respect to said collection of multimedia items.

6. The system of claim 1, wherein said means for observing one or more events include means for translating at least one part of a multimedia item into data in text format.

7. The system of claim 1, wherein said means for observing one or more events include means for retrieving data in text format associated with a multimedia item.

8. The system of claim 1, wherein said context related parameters include a list of one or more multimedia items.

9. The system of claim 1, wherein said context related parameters include a list of one or more topics.

10. The system of claim 1, wherein said context related parameters include a list of one or more topic distributions.

11. The system of claim 1, wherein said means for defining one or more context related parameters for said user include means for analyzing multimedia items.

12. The system of claim 1, wherein said means for processing said one or more events and said one or more context related parameters include means for computing one or more predictions on the basis of said one or more events and said context related parameters.

13. The system of claim 12, wherein said means for processing said one or more events and said one or more context related parameters include means for computing at least one recommendation on the basis of said one or more predictions.

14. The system of claim 1, wherein said means for processing said one or more events and said one or more context related parameters include means for allocating one or more weighting parameters to said one or more context related parameters.

15. The system of claim 14, wherein said means for processing said one or more events and said one or more context related parameters include means for updating said one or more weighting parameters on the basis of said one or more events.

16. The system of claim 12, wherein said means for processing said one or more events and said one or more context related parameters include means for allocating one or more confidence parameters to said one or more predictions.

17. The system of claim 13, wherein each one of said one or more predictions and said recommendation include a ranked list of multimedia items selected from a set including one or more candidates.
